(19) United States
(12) Patent Application Publication
(10) Pub. No.: US 2014/0272827 A1
(43) Pub. Date: Sep. 18, 2014

(54) SYSTEMS AND METHODS FOR MANAGING A VOICE ACTING SESSION

(71) Applicant: ToyTalk, Inc., San Francisco, CA (US)

(72) Inventors: Oren M. Jacobs, Piedmont, CA (US); Martin Reddy, San Francisco, CA (US); Lucas R.A. Ives, Menlo Park, CA (US)

(73) Assignee: TOYTALK, INC., San Francisco, CA (US)

(21) Appl. No.: 13/830,505

(22) Filed: Mar. 14, 2013

(51) Int. Cl. G09B 5/02

(52) U.S. Cl. CPC G09B 5/02
USPC 434/185

(57) ABSTRACT

Various of the disclosed embodiments relate to systems and methods for managing a vocal performance. In some embodiments, a central hosting server may maintain a repository of speech text, waveforms, and metadata supplied by a plurality of development team members. The central hosting server may facilitate modification of the metadata and collaborative commentary procedures so that the development team members may generate higher quality voice assets more efficiently.

### FIELD OF THE INVENTION

Various of the disclosed embodiments relate to systems and methods for managing and/or assessing a vocal performance.

### BACKGROUND

Producing audio assets, and particularly speech assets, for video games, movies, and other large-scale productions can be a long and arduous process. When only a handful of assets need to be created, it may be feasible to isolate the recording process from preceding and subsequent aspects of the development. Unfortunately, for asset intensive projects, where a large number of assets need to be generated, it may be difficult, inefficient, or impossible to apply a traditional development process. Accordingly, there exists a need for systems and methods to integrate the development process across multiple disciplines and to facilitate more rapid production of high quality assets.

### SUMMARY

Certain embodiments contemplate a computer-implemented method for reviewing a vocal performance comprising: transmitting a line of speech text and associated metadata across a network to a user device; and updating the metadata for the line of speech text.

In some embodiments, the metadata is updated based upon attributes of the vocal performance. In some embodiments, the updated metadata includes a plurality of audio waveforms for the vocal performance. In some embodiments, the updated metadata comprises a plurality of take information associated with the plurality of audio waveforms. In some embodiments, the take information comprises an indication of a circle take. In some embodiments, receiving metadata associated with the line of speech text comprises receiving metadata associated with the line of speech text from a second user device, the second user device different from the first user device. In some embodiments, the method further comprises transmitting a plurality of metadata associated with the line of speech text to the second user device. In some embodiments, the first user device is one of a mobile phone, mobile touchpad, laptop computer, or desktop computer. In some embodiments, the method further comprises merging the metadata with a database record associated with the speech waveform. In some embodiments, merging the metadata comprises modifying an entry in a relational database. In some embodiments, the method further comprises receiving a plurality of lines of speech text from a user, the plurality of lines of speech text associated with a unique identifier.

Certain embodiments contemplate a non-transitory computer readable medium comprising instructions configured to cause at least a portion of a computer system to perform a method comprising: transmitting a line of speech text and associated metadata across a network to a first user device; and updating the metadata for the line of speech text.

In some embodiments, the metadata is updated based upon attributes of the vocal performance. In some embodiments, the updated metadata includes a plurality of audio waveforms for the vocal performance. In some embodiments, the updated metadata comprises a plurality of take information associated with the plurality of audio waveforms. In some embodiments, the take information comprises an indication of a circle take. In some embodiments, receiving metadata associated with the line of speech text comprises receiving metadata associated with the line of speech text from a second user device, the second user device different from the first user device. In some embodiments, the method further comprises transmitting a plurality of metadata associated with the line of speech text to the second user device. In some embodiments, the first user device is one of a mobile phone, mobile touchpad, laptop computer, or desktop computer. In some embodiments, the method further comprising merging the metadata with a database record associated with the speech waveform. In some embodiments, merging the metadata comprises modifying an entry in a relational database. In some embodiments, the method further comprises receiving a plurality of lines of speech text from a user, the plurality of lines of speech text associated with an identifier.

Certain embodiments contemplate a computer system for reviewing a vocal performance, the system comprising: a processor; a display; a communication port; a memory containing instructions, wherein the instructions are configured to cause the processor to display a graphical user interface (GUI) on the display, wherein the GUI comprises: a plurality of rows, wherein each row depicts: a line of speech text; a plurality of indicators associated with a plurality of waveforms, the waveforms including a performance of the line of speech.

In some embodiments, each row of the plurality of rows also depicts an input for receiving a note regarding the vocal performance.

Certain embodiments contemplate a computer system for managing a vocal performance comprising: means for receiving lines and metadata across a network; means for identifying the text to be spoken during the vocal performance; means for tracking the number of takes recorded for each line; means for recording notes about the vocal performance; and means for indicating preferred takes, such as circle takes.

In some embodiments, the transmitting means comprises one of a WiFi transmitter, a cellular network transmitter, an Ethernet connection, a radio transmitter, or a local area connection. In some embodiments, the speech waveform receiving means comprises one of a microphone, a WiFi receiver, a cellular network receiver, an Ethernet connection, a radio receiver, a local area connection, or an interface to a transportable memory storage device. In some embodiments, the metadata receiving means comprises one of a WiFi receiver, a cellular network receiver, an Ethernet connection, a radio receiver, a local area connection, or an interface to a transportable memory storage device.

In some embodiments, the speech waveform representation means comprises one of an audio file, a WAV File, an MP3 file, a plurality of frequency components, a compressed audio file, or a plurality of principal components of an audio signal. In some embodiments, the metadata representation means comprises one of an XML file, a text file, a raw data file, a transmission packet, or a SQL entry.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 illustrates a general network topology of certain embodiments of the system.

FIG. 2 illustrates a screenshot of a graphical user interface (GUI) as may be implemented in certain embodiments for initiating a review process.

FIG. 3 illustrates a screenshot of a GUI as a may be implemented in certain embodiments for selecting a role configuration for actively reviewing a session.

FIG. 4 illustrates a screenshot of a GUI as a may be implemented in certain embodiments for actively reviewing a session.

FIG. 5 is a flow diagram depicting a session management process as may be implemented in certain embodiments.

FIG. 6 is a flow diagram depicting a role-selection process as may be implemented in certain embodiments.

FIG. 7 is a flow diagram depicting a take rating portion of a session management process as may be implemented in certain embodiments.

FIG. 8 is a block diagram of a computer system as may be used to implement features of certain of the embodiments.

### DETAILED DESCRIPTION

The following description and drawings are illustrative and are not to be construed as limiting. Numerous specific details are described to provide a thorough understanding of the disclosure. However, in certain instances, well-known details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

### System Overview

Various of the disclosed embodiments relate to systems and methods for managing a vocal performance. In some embodiments, a central hosting server may maintain a repository of speech waveforms and metadata supplied by a plurality of development team members. The central hosting server may facilitate modification of the metadata and collaborative commentary so that the development team members may generate higher quality voice assets more efficiently.

FIG. 1 illustrates a general network topology 100 of certain embodiments of the system. In these embodiments, a central host server 101. System tools 102 may include a plurality of software programs to implement various of the disclosed embodiments and to maintain operation of the host server 101. An authoring software module 103 may include data for receiving authoring and/or commentary edits from various of the users as disclosed herein. Speech data 104 may include waveforms generated by a voice actor 108 or recorded elsewhere, possibly as part of a different asset. Animation data 105, such as keyframes and animation offset data for character speech, may also be stored in a database on the host server 101. Meta-data 106 regarding the use of the speech asset data 104 in an animation or larger collection of media materials may also be accessible to host server 101. A server cache 107 may also be present on the host server 101 and may be used to store various of the described information for ready retrieval.

Each of a voice artist 111, an audio engineer 112, a director 113, or additional individuals involved in the development process may be in communication with the host server 101 and each other, through a plurality of networks 109a-c. In some embodiments, the plurality of networks 109a-c may be the same network, such as a local area network (LAN) or WiFi network. In other embodiments the plurality of networks 109a-c may be the Internet. Through the user interfaces 110a-c of their respective user devices 108a-c, each of the participants, e.g., voice artist 111, audio engineer 112, or director 113, may interact with the host server 101. In certain embodiments, the disclosed applications are run via a service on the host server 101 and appear within a web browser on each user device 108a-c. In some embodiments, each user device 108a-c runs a software application which interfaces with a service running on the host server 101. Portions of the common data reviewed by the participants may be stored locally in caches 115a-c. In some embodiments, as the voice actor 111 receives a line of text from their interface 110a the voice actor 111 may record their performance of the line at microphone 114 and transmit the recorded waveform to host server 101. Simultaneously, or following the recording, the remaining participants and the voice actor 111, may annotate and comment upon the waveform via their respective user devices. In this manner, an entire development team, including graphic designers, directors, post-production editors, etc. may be present during a single recording event, to collaboratively prepare a media asset.

### Graphical User Interface

FIG. 2 illustrates a screenshot of a graphical user interface (GUI) 200 as a may be implemented in certain embodiments for initiating a review process at a user device. The GUI 200 may appear on one of the user devices 108a-c in a browser, as an application running on the user device, etc. In this example of these embodiments, a configure icon 201 may be used to initiate a review process session. Selection of the icon 201 displays a configuration panel 202. The panel 202 may depict a role selection 203. By selecting a role, a user may be presented with a different interface as described in greater detail below with reference to FIG. 6. The session ID field 204 may be used to indicate the current asset to be generated/reviewed. A writer may have previously generated a list of lines of text to be performed by a voice actor and submitted those lines to the system. The lines may be collected into “subprojects” which appear as the sessions in the session ID field 204. The interface may present the user with a list of sessions 205a-e from which to select. An identifier 206 may be used to identify the current selection. Each of the sessions 205a-e may be represented with a textual descriptor. Here, for example, the descriptor “tt_vo_toytalk_{—}130213” may indicate that the session is a “voice-over”, “vo” with an identification number 130213. A remarks section indicates that the session is for the organization “toytalk” though the remarks may also be used to indicate the digital character for whom the audio assets are being created, or the scene or portion of the production in which the lines may appear. The “tt” indicator may indicate the project category or the client for whom the asset is being prepared.

FIG. 3 illustrates a screenshot of a GUI as a may be implemented in certain embodiments for selecting a role configuration for actively reviewing a session. After selecting the role selection icon 203 the system may present the user with a list of possible role selections 301a-e. For purposes of explanation, in this example the roles include a director, a talent or voice actor role, an audio engineer, a reviewer, and a writer. Selection of a role may generate additional or reduced functionality in the active scene 400 where the various lines within a selected session will appear. For example, in the “director” role the user may have complete access to all of the available functionality, including the ability to edit the comments and selections of other users and the ability to make a final determination regarding a take. In contrast, a user in the “talent”, or “voice actor”, role may only be able to see a line when it is presented to them by another user, and to append textual notes to the line to serve as reminders during their performance.

FIG. 4 illustrates a screenshot of a GUI as a may be implemented in certain embodiments for actively reviewing a session. Particularly, FIG. 4 illustrates an active scene 400 as may be displayed to a user, e.g. a reviewer, following a role selection via the interface of FIG. 3. Having selected a session, the application may present a list of lines 407 via a list of rows 406a-i. Each row 406a-i may include a numerical identifier 413, a textual indication of the line 407, a list of references 408 (the number “1” referring to the first reference, “2” to the second, etc.) to the takes performed by the voice actor, and notes 409. As indicated by the highlighted background color of the row, row 406f is presently selected. For ease of selection, the seven audio takes by the voice actor associated with item #006 may appear as larger quick access buttons 403a-g following selection of the row. After selecting a row, the system may also populate certain contextual fields to help identify the location of the session or the selected line within the larger project context. In this example, the system has indicated that the line is part of the category “You Vs. ?” in the field 412 and the particular activity associated with the line of text “Child: ‘Activity: You Vs./Group: Blackbeard’” in the field 410. These contextual notes may be specified by a writer at the time of the creation of the line of text. In some embodiments, the notes are automatically populated based on the session identification information indicated in the list 205a-e.

After the actor has performed all the lines, or even during the performance of a line, the other participants may review and indicate a “good” or “best” take, referred to herein as a “circle take”. In the illustrated example, the sixth take appears highlighted in both the quick access button 403f and in the sixth indicator of the row 406f. As an example, an audio engineer may listen as a voice actor performs successive repetitions of the line “It's You! Versus! Blackbeard the Pirate!” as each of takes 1-7. Between the takes, or following consideration of all the takes, the audio engineer may select a take as the “circle take”, in this case, take 6 (in some embodiments by clicking on the quick access button 403f). In some embodiments, a user may review the entries of other team members, and may compare the other members' identified “circle takes” with their own. In some embodiments, the “circle takes” may constitute a form of “voting”, in which each user indicates their preferred take, and the majority is indicated for future use and/or review.

For each selected take, the user may supply notes 409 to explain their reasoning, or to identify errors or improvements in the performance. These notes may be available in near real-time to the voice actor, so that they may adjust their performance in subsequent takes. In some embodiments, the waveform of the actor's performance is provided to the user for review, and notes may be placed along the waveform timeline to indicate where in the speech the note refers. In some embodiments, notes are not only textual indications, but may also be markers for subsequent animation techniques. For example, in some embodiments, the team present during the recording process includes one or more animator. Via the “animator” role, the user may indicate notes in the waveform concerning keyframes for animation and aspects of speech that may require further consideration when preparing a digital animation. Some embodiments allow the animator to make graphical notes, such as sketches, to illustrate, e.g., how the character would adapt based on the waveform generated by the voice actor. Using buttons 404 and 405 the participants can save their changes and upload the results to the server for access by other users. In this manner, an entire production team from several stages of a production process may join together and provide editing and review of voice acting for rapid creation of audio assets.

### Session Operations

FIG. 5 is a flow diagram depicting a session management process 500 as may be implemented in certain embodiments. In some embodiments, the process 500 may be run on host server 101. In other embodiments, session management may be run exclusively on the user devices. For example, one user device may be designated the “host server” and perform the centralizing functions of the host. In other embodiments, every user device is a “host” and updates are distributed to all the devices in a distributed fashion.

At step 501, the system may receive a line of text, such as a line of conversation, from a writer. As discussed above, the writer, or another role member, may specify the initial configuration of the project, and may specify where the supplied lines of text will be used in the final design. Particularly, at step 502, the system may associate the line of text with a recording session. For example, the writer may have previously specified that the collection of lines of texts they were about to be entered were to be associated with a particular portion of a production. In some embodiments, the system may automatically identify the session to be associated with the text based on previous entries or other context.

At step 503, a user, such as an audio engineer, voice actor, or a director may select the session identifier, e.g., an identifier 205a-e in their own user device. At step 504, possibly in response to the selection at step 503, or as part of an automatic update process, the system may send session data to the user's local device.

At step 505 the system may present metadata with the line of text to a voice actor. For example, a team member may have previously appended notes 409 to a row in active scene 400. Now that the voice actor is about to speak the line of text, the voice actor may review the notes before beginning their performance.

At step 506, the system may receive a speech waveform associated with the line of text from a voice actor. For example, the data sent to the user's local device at step 504, may have included sending the line of text to be spoken by the voice actor to the voice actor's local device. The voice actor may review the text and speak the line into a microphone.

At step 507 the system may receive metadata associated with the line of text from a user. The metadata may be, e.g., notes 409 taken by an audio engineer, or an indication of the circle take indicated by a member of the team.

At step 508 the system may merge the metadata with the information in the database concerning the voice actor's performance. For example, the host server 101 may include or have access to a SQL database and may update an entry to reflect a user's notes or circle take regarding a voice actor's performance.

In some embodiments, at step 509 the system may perform post-processing. For example, where the metadata received at step 508 includes notations or markings regarding future animation work, the system may prepare, or direct the preparation of, initial animation riggings or keyframes to conform to the user's annotations. For example, where a user has indicated a signal processing technique to be applied to a portion of the voice actor's waveform, the system may apply the signal processing technique and store a post-processed version of the waveform for the team's review.

FIG. 6 is a flow diagram depicting a role-selection process 600 as may be implemented in certain embodiments. In some embodiments, the process 600 may be run on host server 101. For the purposes of explanation, only the “Director”, “Voice Actor”, and “Audio Engineer” roles have been presented, though one will recognize that an arbitrary number of roles may be created and/or used by users of the system. At step 601 the system may receive a selection of a role identification, such as via configuration panel 202 as depicted in FIG. 3. If at step 602 the system determines that the field indicates a director status, the system may present the “director functionality” to the user at step 605. If at step 603 the system determines that the field indicates a voice actor status, the system may present the “voice actor functionality” to the user at step 606. If at step 604 the system determines that the field indicates an audio engineer status, the system may present the “audio engineer functionality” to the user at step 607.

In some embodiments, the system may consult a database containing user information before presenting data at steps 605-7. If the user has selected a step for which they have not sufficient privileges, the system may notify the user and/or redirect the user to an acceptable role. In some embodiments the system may not allow a user to take a role if another user has already taken that role. In some embodiments, a writer or director may initially specify the number of allowable users per role in a project.

FIG. 7 is a flow diagram depicting a “take rating” portion 700 of a session management process as may be implemented in certain embodiments. In some embodiments, the process 700 may be run on host server 101. At step 701, the system may present a line of text to a voice actor. At step 702, the system may receive a first speech waveform from the voice actor associated with the line of text. At step 703, the system may receive a first rating associated with the first speech waveform. For example, the system may receive an indication for a user that the waveform is a “circle take”, using a quick access button. In some embodiments, the absence of an indication from a user before a new waveform is received, e.g. at step 703, may indicate that the user has not ranked the first waveform as a “circle take” or that the first waveform is not to be ranked highly. At step 704, the system may receive a new take from the voice actor as a second waveform. At step 705, the system may receive a second rating associated with the second speech waveform.

### Computer System Overview

Various embodiments include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 8 an example of a computer system 800 with which various embodiments may be utilize. Various of the disclosed features may be located on computer system 800. According to the present example, the computer system includes a bus 805, at least one processor 810, at least one communication port 815, a main memory 820, a removable storage media 825, a read only memory 830, and a mass storage 835.

Processor(s) 810 can be any known processor, such as, but not limited to, an Intel® Itanium® or Itanium 2® processor(s), or AMD® Opteron® or Athlon MP® processor(s), or Motorola® lines of processors. Communication port(s) 815 can be any of an RS-232 port for use with a modem based dialup connection, a 10/100 Ethernet port, or a Gigabit port using copper or fiber. Communication port(s) 815 may be chosen depending on a network such a Local Area Network (LAN), Wide Area Network (WAN), or any network to which the computer system 800 connects.

Main memory 820 can be Random Access Memory (RAM), or any other dynamic storage device(s) commonly known in the art. Read only memory 830 can be any static storage device(s) such as Programmable Read Only Memory (PROM) chips for storing static information such as instructions for processor 810.

Mass storage 835 can be used to store information and instructions. For example, hard disks such as the Adaptec® family of SCSI drives, an optical disc, an array of disks such as RAID, such as the Adaptec family of RAID drives, or any other mass storage devices may be used.

Bus 805 communicatively couples processor(s) 810 with the other memory, storage and communication blocks. Bus 805 can be a PCI/PCI-X or SCSI based system bus depending on the storage devices used.

Removable storage media 825 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

The components described above are meant to exemplify some types of possibilities. In no way should the aforementioned examples limit the scope of the invention, as they are only exemplary embodiments.

While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations. Therefore, the above description should not be taken as limiting the scope of the invention.

### Remarks

While the computer-readable medium is shown in an embodiment to be a single medium, the term “computer-readable medium” should be taken to include a single medium or multiple media (e.g., a centralized or distributed database, and/or associated caches and servers) that stores the one or more sets of instructions. The term “computer-readable medium” shall also be taken to include any medium that is capable of storing, encoding or carrying a set of instructions for execution by the computer and that cause the computer to perform any one or more of the methodologies of the presently disclosed technique and innovation.

The computer may be, but is not limited to, a server computer, a client computer, a personal computer (PC), a tablet PC, a laptop computer, a set-top box (STB), a personal digital assistant (PDA), a cellular telephone, an iPhone®, an iPad®, a processor, a telephone, a web appliance, a network router, switch or bridge, or any machine capable of executing a set of instructions (sequential or otherwise) that specify actions to be taken by that machine.

In general, the routines executed to implement the embodiments of the disclosure, may be implemented as part of an operating system or a specific application, component, program, object, module or sequence of instructions referred to as “programs,” The programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, various embodiments are capable of being distributed as a program product in a variety of forms, and that the disclosure applies equally regardless of the particular type of computer-readable medium used to actually effect the distribution.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for the disclosure, are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teaching of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limited the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A computer-implemented method for managing a vocal performance comprising:
transmitting a line of speech text across a network to a first user device;
receiving metadata associated with the line of speech text; and
updating the metadata associated with the line of speech text.

2. The method of claim 1, wherein the updated metadata associated with a line of speech text comprises a plurality of speech waveforms recorded during the vocal performance.

3. The method of claim 2, wherein the updated metadata comprises information for each take that was recorded for a given line of speech text.

4. The method of claim 3, wherein the take information comprises an indication of one or more circle takes.

5. The method of claim 1, wherein the updated metadata comprises notes describing the vocal performance for a line of speech text.

6. The method of claim 1, wherein receiving metadata associated with the line of speech text comprises receiving metadata associated with the line of speech text from a second user device, the second user device different from the first user device.

7. The method of claim 6, further comprising transmitting a plurality of metadata associated with the line of speech text to the second user device.

8. The method of claim 1, wherein the first user device is one of a mobile phone, mobile touchpad, laptop computer, or desktop computer.

9. The method of claim 1, further comprising merging the metadata with a database record associated with the speech waveform.

10. The method of claim 9, wherein merging the metadata comprises modifying an entry in a relational database.

11. The method of claim 1, further comprising receiving a plurality of lines of speech text from a user, the plurality of lines of speech text associated with a unique identifier.

12. A non-transitory computer readable medium comprising instructions configured to cause at least a portion of a computer system to perform a method comprising:
transmitting a line of speech text across a network to a first user device;
receiving metadata associated with the line of speech text; and
updating the metadata associated with the line of speech text.

13. The non-transitory computer readable medium of claim 12, wherein the updated metadata associated with a line of speech text comprises a plurality of speech waveforms recorded during the vocal performance

14. The non-transitory computer readable medium of claim 12, wherein the updated metadata comprises information for each take that was recorded for a given line of speech text.

15. The non-transitory computer readable medium of claim 14, wherein the take information comprises an indication of one or more circle takes.

16. The non-transitory computer readable medium of claim 12, wherein receiving metadata associated with the line of speech text comprises receiving metadata associated with the line of speech text from a second user device, the second user device different from the first user device.

17. The non-transitory computer readable medium of claim 16, the method further comprising transmitting a plurality of metadata associated with the line of speech text to the second user device.

18. The non-transitory computer readable medium of claim 12, wherein the first user device is one of a mobile phone, mobile touchpad, laptop computer, or desktop computer.

19. The non-transitory computer readable medium of claim 12, the method further comprising merging the metadata with a database record associated with a speech waveform.

20. The non-transitory computer readable medium of claim 19, wherein merging the metadata comprises modifying an entry in a relational database.

21. The non-transitory computer readable medium of claim 12, the method further comprising receiving a plurality of lines of speech text from a user, the plurality of lines of speech text associated with an identifier.

22. A computer system for managing a vocal performance, the system comprising:
a processor;
a display;
a communication port;
a memory containing instructions, wherein the instructions are configured to cause the processor to display a graphical user interface (GUI) on the display, wherein the GUI comprises:
a plurality of rows, wherein each row depicts:
a line of speech text;
a line number associated with the speech text; and
indicators for the plurality of waveforms recorded for the line of speech text;

23. The computer system of claim 22, wherein each row of the plurality of rows also depicts an input for receiving a note regarding at least one of the waveforms.

24. A computer system for managing a vocal performance comprising:
means for transmitting a plurality of lines to a user device;
means for identifying the sequence of lines to be spoken during the vocal performance;
means for receiving speech waveforms for each line;
means for tracking the number of takes recorded for each line;
means for recording notes about the vocal performance; and
means for indicating preferred takes.

25. The computer system of claim 24, wherein the transmitting means comprises one of a WiFi transmitter, a cellular network transmitter, an Ethernet connection, a radio transmitter, or a local area connection.

26. The computer system of claim 24, wherein the speech waveform receiving means comprises one of a microphone, a WiFi receiver, a cellular network receiver, an Ethernet connection, a radio receiver, a local area connection, or an interface to a transportable memory storage device.

27. The computer system of claim 24, wherein the metadata receiving means comprises one of a WiFi receiver, a cellular network receiver, an Ethernet connection, a radio receiver, a local area connection, or an interface to a transportable memory storage device.

28. The computer system of claim 24, wherein the speech waveform representation means comprises one of an audio file, a WAV File, an MP3 file, a plurality of frequency components, a compressed audio file, or a plurality of principal components of an audio signal.

29. The computer system of claim 24, wherein the metadata representation means comprises one of an XML file, a text file, a raw data file, a transmission packet, or a SQL entry.
